(19) United States
(12) Patent Application Publication
(10) Pub. No.: US 2018/0213402 A1
(43) Pub. Date: Jul. 26, 2018

(54) SECURITY AWARE INSTANTIATION OF NETWORK SERVICES AND/OR VIRTUALIZED NETWORK FUNCTIONS

(71) Applicant: NOKIA SOLUTIONS AND NETWORKS OY, Espoo (FI)

(72) Inventors: John HARRIS, Whitefish Bay, WI (US); Umamaheswar KAKINADA, Carpentersville, IL (US); Anatoly ANDRIANOV, Schaumburg, IL (US)

(73) Assignee: Nokia Solutions and Networks Oy, Espoo (FI)

(21) Appl. No.: 15/744,368

(22) PCT Filed: Jul. 15, 2015
(86) PCT No.: PCT/US2015/040587

§ 371 Date: Jan. 12, 2018

(51) Int. Cl. H04W 12/08; H04L 29/06

(52) U.S. Cl. CPC H04W 12/08; H04L 63/105; H04L 63/20

(57) ABSTRACT

It is provided a method, comprising comparing a security requirement for a higher level function with respective security levels of one or more virtualized lower level functions, wherein each of the one or more virtualized lower level functions is capable to deploy the higher level function; selecting a selected virtualized lower level function of the one or more virtualized lower level functions, wherein the security level of the selected virtualized lower level function is equal to or higher than the security requirement; instantiating the higher level function on the selected virtualized lower level function.

### FIELD OF THE INVENTION

The present invention relates to an apparatus, a method, and a computer program product related to instantiation of network services and/or virtualized network functions. More particularly, the present invention relates to an apparatus, a method, and a computer program product related to security aware instantiation of network services and/or virtualized network functions.

Abbreviations

3GPP 3rd Generation Partnership Project

COTS Commercially of the shelf

ETSI European Telecommunications Standards Institute

GS Group Specification

KPI Key Performance Indicator

LTE Long Term Evolution

LTE-A LTE Advanced

MANO Management and Orchestration

NF Network Function

NFV Network Functions Virtualisation

NFVI Network Functions Virtualisation Infrastructure

NS Network Service

NSD Network Service Descriptor

PNF Physical Network Function

PoP Point of Presence

QoS Quality of Service

SDN Software-defined Networking

SLA Service Level Agreement

VL Virtual Link

VNF Virtualised Network Function

VNFC Virtualised Network Function Component

VNFD Virtualised Network Function Descriptor

Glossary

If not otherwise explained in the present description, the terms used herein have a meaning as according to ETSI GS NFV 003 V1.2.1 (2014-12): “Network Functions Virtualisation (NFV); Terminology for Main Concepts in NFV”. For self-containment, the relevant definitions are repeated:

Network Function (NF): functional block within a network infrastructure that has well-defined external interfaces and well-defined functional behaviour.

Network Functions Virtualisation (NFV): principle of separating network functions from the hardware they run on by using virtual hardware abstraction.

Network Functions Virtualisation Infrastructure (NFVI): totality of all hardware and software components that build up the environment in which VNFs are deployed. For example, this includes storage & network infrastructure and hypervisor.

Network Functions Virtualisation Infrastructure (NFVI) components: NFVI hardware resources that are not field replaceable, but are distinguishable as COTS components at manufacturing time

Network service: composition of Network Functions and defined by its functional and behavioral specification

Network service descriptor: template that describes the deployment of a Network Service including service topology (constituent VNFs and the relationships between them, Virtual Links, VNF Forwarding Graphs) as well as Network Service characteristics such as SLAs and any other artefacts necessary for the Network Service on-boarding and lifecycle management of its instances This includes service chaining represented by the VNF forwarding graph.

Physical Network Function (PNF): implementation of a NF via a tightly coupled software and hardware system

Virtual link: set of connection points along with the connectivity relationship between them and any associated target performance metrics (e.g. bandwidth, latency, QoS)

Virtualized Network Function (VNF): implementation of an NF that can be deployed on one or more Network Function Virtualization Infrastructure (NFVI) PoPs.

Virtualized Network Function Instance (VNF Instance): run-time instantiation of the VNF software, resulting from completing the instantiation of its components and of the connectivity between them, using the VNF deployment and operational information captured in the VNFD, as well as additional run-time instance-specific information and constraints

Virtualised Network Function Descriptor (VNFD): configuration template that describes a VNF in terms of its deployment and operational behaviour, and is used in the process of VNF on-boarding and managing the lifecycle of a VNF instance.

Throughout the present application, if not otherwise indicated or made clear from the context, the terms “network function” and “network service” are used synonymously, i.e. a network function may be considered as a network service consisting of only this one network function.

However, in general, the terms “network function” and “network service” are not synonymous. Namely, a network service may consist of many network functions. As previously discussed, a network service may be a composition of Network Functions and is defined by its functional and behavioral specification. Furthermore—a Network service descriptor is a template that describes the deployment of a Network Service including service topology (constituent VNFs and the relationships between them, Virtual Links, VNF Forwarding Graphs) as well as Network Service characteristics such as SLAs and any other artifacts necessary for the Network Service on-boarding and lifecycle management of its instances. This includes service chaining represented by the VNF forwarding graph.

Throughout the present application, the terms “higher level function” and “lower level function” are used. For example, the higher level function may be a network service or a virtual network function and the lower level function may be a network function on which the network service or network function is implemented. As another example, the higher level function may be a network service and the lower level function may be a virtual network function on which the network service or network function is implemented. As another example, the higher level function may be a virtual network function and the lower level function may be a networks functions virtualization infrastructure on which the virtual network function is implemented.

A “capability” describes a property of a “lower level function” to provide a particular function to one or more “higher level functions”.

### BACKGROUND OF THE INVENTION

In the MANO security framework progress is being made on defining the mechanisms which enable instantiation of different instances of virtualized network functions as a function of resource requirements.

Traditionally network functions were run inside the operator's network, and provided a consistent level of security, e.g. over time.

Patent Application No.: PCT/US2015/028533 (Filing date: Apr. 30, 2015) describes mechanisms for using a per subscriber security estimate to route users traffic, e.g. determining which users should be allocated to which of two different virtualized network function instances, based on the security requirement of that user, where the two different instantiations were created to have two different types of security.

### SUMMARY OF THE INVENTION

It is an object of the present invention to improve the prior art.

According to a first aspect of the invention, there is provided an apparatus, comprising comparing means adapted to compare a security requirement for a higher level function with respective security levels of one or more virtualized lower level functions, wherein each of the one or more virtualized lower level functions is capable to deploy the higher level function; selecting means adapted to select a selected virtualized lower level function of the one or more virtualized lower level functions, wherein the security level of the selected virtualized lower level function is equal to or higher than the security requirement; instantiating means adapted to instantiate the higher level function on the selected virtualized lower level function.

The higher level function may be a network service or a network function and the lower level function may be a virtual network function, and/or the higher level function may be a virtual network function and the lower level function may be a networks functions virtualization infrastructure.

The selecting means may be additionally adapted to take into account, for selecting the selected lower level function, at least one of a future security requirement for the higher level function, a scalability of the higher level function deployed on the selected lower level function, costs to deploy the higher level function on the selected lower level function, and a performance of the higher level function deployed on the selected lower level function.

The security requirement and each of the security levels may be expressed by a respective numerical value; the comparing means may be adapted to compare the numerical value of the security requirement with the respective numerical value of each of the one or more lower level functions; the selecting means may be adapted to select the selected lower level function if the numerical value of the security requirement and the numerical value of the security level of the selected lower level function fulfill a predetermined relationship.

The security requirement may comprise plural security sub-requirements and each of the security levels may comprise corresponding plural security sub-levels; the comparing means may be adapted to compare one or more of the plural security sub-requirements with the corresponding security sub-level of each of the virtualized lower level functions; the selecting means may be adapted to select the selected virtualized lower level function if each of the compared security sub-levels of the selected virtualized lower level function is equal to or higher than the corresponding security sub-requirement.

The security requirement may comprise plural sub-requirements and each of the security levels comprises corresponding plural security sub-levels; and the apparatus may comprise determining means adapted to determine a global security requirement based on one or more of the plural security sub-requirements and to determine a respective global security level for each of the lower level functions based on the corresponding one or more of the security sub-levels; wherein the comparing means may be adapted to compare the global security requirement with the respective global security levels; the selecting means may be adapted to select the selected virtualized lower level function if the global security level of the selected virtualized lower level function is equal to or higher than the global security requirement.

The apparatus may further comprise control means adapted to control the comparing means, the selecting means, and the instantiating means such that, in a first step, the higher level function is a network service or a network function, the virtualized lower level functions are virtualized network functions, and the selected virtualized lower level function is one of the virtualized network functions, and, in a second step following the first step, the higher level function is the selected virtualized network function, the virtualized lower level functions are network functions virtualization infrastructures, and the selected virtualized lower level function is one of the network functions virtualization infrastructures.

The apparatus may further comprise determining means adapted to determine at least one of the security levels based on at least one of an attribute, a location, a vendor, a virtualization type, and other tenants of the respective virtualized lower level function.

According to a second aspect of the invention, there is provided an apparatus, comprising comparing circuitry configured to compare a security requirement for a higher level function with respective security levels of one or more virtualized lower level functions, wherein each of the one or more virtualized lower level functions is capable to deploy the higher level function; selecting circuitry configured to select a selected virtualized lower level function of the one or more virtualized lower level functions, wherein the security level of the selected virtualized lower level function is equal to or higher than the security requirement; instantiating circuitry configured to instantiate the higher level function on the selected virtualized lower level function.

The higher level function may be a network service or a network function and the lower level function may be a virtual network function, and/or the higher level function may be a virtual network function and the lower level function may be a networks functions virtualization infrastructure.

The selecting circuitry may be additionally configured to take into account, for selecting the selected lower level function, at least one of a future security requirement for the higher level function, a scalability of the higher level function deployed on the selected lower level function, costs to deploy the higher level function on the selected lower level function, and a performance of the higher level function deployed on the selected lower level function.

The security requirement and each of the security levels may be expressed by a respective numerical value; the comparing circuitry may be configured to compare the numerical value of the security requirement with the respective numerical value of each of the one or more lower level functions; the selecting circuitry may be configured to select the selected lower level function if the numerical value of the security requirement and the numerical value of the security level of the selected lower level function fulfill a predetermined relationship.

The security requirement may comprise plural security sub-requirements and each of the security levels may comprise corresponding plural security sub-levels; the comparing circuitry may be configured to compare one or more of the plural security sub-requirements with the corresponding security sub-level of each of the virtualized lower level functions; the selecting circuitry may be configured to select the selected virtualized lower level function if each of the compared security sub-levels of the selected virtualized lower level function is equal to or higher than the corresponding security sub-requirement.

The security requirement may comprise plural sub-requirements and each of the security levels comprises corresponding plural security sub-levels; and the apparatus may comprise determining circuitry configured to determine a global security requirement based on one or more of the plural security sub-requirements and to determine a respective global security level for each of the lower level functions based on the corresponding one or more of the security sub-levels; wherein the comparing circuitry may be configured to compare the global security requirement with the respective global security levels; the selecting circuitry may be configured to select the selected virtualized lower level function if the global security level of the selected virtualized lower level function is equal to or higher than the global security requirement.

The apparatus may further comprise control circuitry configured to control the comparing circuitry, the selecting circuitry, and the instantiating circuitry such that, in a first step, the higher level function is a network service or a network function, the virtualized lower level functions are virtualized network functions, and the selected virtualized lower level function is one of the virtualized network functions, and, in a second step following the first step, the higher level function is the selected virtualized network function, the virtualized lower level functions are network functions virtualization infrastructures, and the selected virtualized lower level function is one of the network functions virtualization infrastructures.

The apparatus may further comprise determining circuitry configured to determine at least one of the security levels based on at least one of an attribute, a location, a vendor, a virtualization type, and other tenants of the respective virtualized lower level function.

According to a third aspect of the invention, there is provided a method, comprising comparing a security requirement for a higher level function with respective security levels of one or more virtualized lower level functions, wherein each of the one or more virtualized lower level functions is capable to deploy the higher level function; selecting a selected virtualized lower level function of the one or more virtualized lower level functions, wherein the security level of the selected virtualized lower level function is equal to or higher than the security requirement; instantiating the higher level function on the selected virtualized lower level function.

The higher level function may be a network service or a network function and the lower level function may be a virtual network function, and/or the higher level function may be a virtual network function and the lower level function may be a networks functions virtualization infrastructure.

The selecting may take additionally into account, for selecting the selected lower level function, at least one of a future security requirement for the higher level function, a scalability of the higher level function deployed on the selected lower level function, costs to deploy the higher level function on the selected lower level function, and a performance of the higher level function deployed on the selected lower level function.

The security requirement and each of the security levels may be expressed by a respective numerical value; the numerical value of the security requirement may be compared with the respective numerical value of each of the one or more lower level functions; the selected lower level function may be selected if the numerical value of the security requirement and the numerical value of the security level of the selected lower level function fulfill a predetermined relationship.

The security requirement may comprise plural security sub-requirements and each of the security levels may comprise corresponding plural security sub-levels; one or more of the plural security sub-requirements may be compared with the corresponding security sub-level of each of the virtualized lower level functions; the selected virtualized lower level function may be selected if each of the compared security sub-levels of the selected virtualized lower level function is equal to or higher than the corresponding security sub-requirement.

The security requirement may comprise plural sub-requirements and each of the security levels may comprise corresponding plural security sub-levels; and the method may comprise determining a global security requirement based on one or more of the plural security sub- requirements and to determine a respective global security level for each of the lower level functions based on the corresponding one or more of the security sub-levels; wherein the global security requirement may be compared with the respective global security levels; the selected virtualized lower level function may be selected if the global security level of the selected virtualized lower level function is equal to or higher than the global security requirement.

The method may further comprise controlling the comparing of the security requirement with the respective security levels, the selecting of the selected virtualized lower level function, and the instantiating of the higher level function such that, in a first step, the higher level function is a network service or a network function, the virtualized lower level functions are virtualized network functions, and the selected virtualized lower level function is one of the virtualized network functions, and, in a second step following the first step, the higher level function is the selected virtualized network function, the virtualized lower level functions are network functions virtualization infrastructures, and the selected virtualized lower level function is one of the network functions virtualization infrastructures.

The method may further comprise determining at least one of the security levels based on at least one of an attribute, a location, a vendor, a virtualization type, and other tenants of the respective virtualized lower level function.

The method may be a method of instantiation.

According to a fourth aspect of the invention, there is provided a computer program product comprising a set of instructions which, when executed on an apparatus, is configured to cause the apparatus to carry out the method according to the third aspect. The computer program product may be embodied as a computer-readable medium or directly loadable into a computer.

According to some example embodiments of the invention, at least one of the following technical effects is provided:
instantiation of network services and/or virtualized network functions takes account of security requirements;
future security requirements may be considered in the instantiation;
mechanism may be reused at different levels of virtualization.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of example embodiments of the present invention which is to be taken in conjunction with the appended drawings, wherein

FIG. 1 shows an apparatus according to an example embodiment of the invention;

FIG. 2 shows a method according to an example embodiment of the invention; and

FIG. 3 shows an apparatus according to an example embodiment of the invention.

### DETAILED DESCRIPTION OF CERTAIN EXAMPLE EMBODIMENTS

Herein below, certain example embodiments of the present invention are described in detail with reference to the accompanying drawings, wherein the features of the example embodiments can be freely combined with each other unless otherwise described. However, it is to be expressly understood that the description of certain embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

In the MANO security framework, 3GPP standard instantiation process in response to security needs is not considered. For example, in section 7.1 (for NS) and 7.2 (for VNF) of gs_NFV-MAN001v010101p—Management and Orchestration a security treatment across/within the subsections is lacking.

Different network operators have different security needs. Additionally, the operator's security needs may change over time. There are numerous different capabilities which can be used to meet the requirements of the operator's network service. There is a need for enabling the operator's instantiation of a network service which meets the operator's security requirement, while managing the way in which that security requirement matches the possible capabilities for satisfying those requirements, and the operator's need to provide the best performing solution while considering other factors such as the anticipated future security requirements.

Some embodiments of the invention bring the network service security requirements and the available capabilities “together” while instantiating a NS and/or VNF using the MANO framework.

In contrast to PCT/US2015/028533, some embodiments of the invention are related to the instantiation process. For example, there may be only a single instantiation or plural instantiations. Some embodiments of the invention may include steps such as taking the NS's security requirements, and then using them to identify a set of NVF capabilities which meet the NS's security requirements. This may lead to a selection and creation of a VNF instantiation which meets the NS security requirements.

Some embodiments of the invention are related to creating an instantiation, and/or some embodiments of the invention are related to updating an instantiation.

Some embodiments of the invention provide standards enablers for using security, to impact/trigger the instantiation (and scaling and termination) of NS (network service) and VNF (virtual network function). As mentioned, previous standards work focused on instantiation, scaling, and termination of virtual network function instances based on resource requirements.

Some embodiments cover the process of matching the security requirements of the NS with the security capabilities available in the VNF, so that the resource allocation is optimized. In addition, anticipated future security requirements, cost, performance, scalability, etc. may be considered when selecting among the capabilities meeting the security NS constraints.

Instead of the security requirements of the NS, in some embodiments of the invention, those of a VNF maybe matched with the security capabilities of the NFVI.

Since the mechanisms are substantially the same, in the former case, the NS may be considered as a higher level function and the VNF as a virtualized lower level function.

Correspondingly, in the latter case, the VNF may be considered as a higher level function and the NFVI as a virtualized lower level function. In these terms, in some embodiments of the invention, the security requirements of the higher level function are matched with the security capabilities available in the virtualized lower level function.

In the following, some embodiments of the invention are described, where NS is the higher level function. The following steps may be performed:

NS security requirements used to select its (next level) capabilities
1) NS security requirements are used to select one or more candidate capabilities (i.e. VNFs having respective functional capabilities) meeting the NS security requirements.
   a. NS requirements
      i. Represents the security parameters and its requirement for each deployment flavour of the NS being described. The requirements may be called security trust level requirement.
      ii. In some embodiments, the security trust level requirement may be stated as a score between e.g. 1 and 100. In some of these embodiments, lower values are more trusted. In some of these embodiments, the score value has to be below a threshold. In other of these embodiments, higher values are more trusted. In some of these embodiments, the score value has to be higher than a threshold.
      iii. In some embodiments, there may be a requirement value for capabilities within specific subareas. E.g. there might be a required value for the vendor specific attributes, in addition to an overall trust level requirement.
      iv. The security_deployment_flavour has a cardinality from 1 to N within the network service descriptor (NSD) (N=1, 2, 3, . . . ). I.e., there may be an entry of a security trust level requirement for each of several subareas, the overall security, and the anticipated future (overall) security.
      v. In one example with N=3,
         1. The first value of the security_deployment_flavour requirement conveys the requirement on the overall security of the NS.
         2. The second value of the security_deployment_flavour requirement conveys the requirement on vendor specific attributes of the NS.
         3. A third value may convey an anticipated future security requirement of the NS. This future requirement does not yet need to be met, but the system can potentially avoid updating the supporting capabilities, when this future requirement becomes a current requirement. This future requirement may also have a future time associated with it (i.e., a time when the future security requirements have to be met).
   b. These NS security requirements are then used to identify a set of capabilities (i.e. VNFs with respective capabilities), that meet the NS security requirements. I.e, based on security levels of the VNFs, it may be determined if the NS implemented on the VNF(s) fulfills the NS security requirements. The security levels of the VNFs may be expressed by security attributes.
      i. This step of identification of capabilities may further trigger performing the steps in the next section. I.e., taking the VNF capabilities, a set of VNF security requirements may be determined, which then in turn are used to determine the supporting set of underlying capabilities such as NFVI capabilities including hardware capabilities, software capabilities and network capabilities.
   c. The security metric for a given set of capabilities may be calculated using the (security) attributes of the individual capabilities. For example, an average may be calculated across the individual capability values (wherein each capability value has a security value between 1 and 100). The average may be weighted according to a relative importance of some criteria. Instead of an average, a median or a minimum (maximum) value may be determined.
   d. The individual capabilities, for which security attributes may be determined, may include one or more of e.g.:
      i. VNF capabilities example
         1. Attribute Description
         2. Location US, China, Canada
         3. Vendor Trusted/Un-trusted, vendor id, description
         4. Virtualization type Private/Public/Hybrid
         5. Other tenants Trusted/Un-trusted
   e. By an implementation dependent function (E.g. sum) according to some embodiments of the invention, the NS composite security metric attributes may be derived.
      i. For example, as discussed, an average is calculated across the individual capability values (where each capability value has a security value between 1 and 100)
      ii. This average is then compared with the overall required value (the security requirement) for the NS (as described earlier).
      iii. When there is a requirement on a single value, this may be an example of a “discriminative requirement,” e.g. where it is absolutely required that a security requirement in a certain area is matched. For example, certain vendors may not be allowed. For example, the second value of the security_deployment_flavour requirement conveys the requirement on specific vendor attributes of the NS. If certain vendors are not allowed, the respective attribute should be high (in case, lower values mean higher trust) such that they are above a threshold value.
2) In the case where the future security requirement is higher than the current security requirement, some embodiments of the invention may additionally identify capabilities which satisfy the future security requirement.
3) After identifying this set of candidates capabilities (meeting the NS security requirement) are identified, a further optimization process may be used to select among the candidates, by taking into account factors such as scalability, cost, and performance.
   a. The cost and performance difference between the capabilities meeting the current and future requirements may then be compared with respective thresholds. These thresholds may further be calculated as a function of the processing or messaging costs required to update an instantiation, changing the capabilities, etc.
4) Once the specific capabilities are selected, then a NS security value may be calculated to represent the actual security metric for the selected set of VNF capabilities.
   a. In this case note that the security metric for the selected set of capabilities value, can actually have a lower value than the corresponding NS requirement according to the NSD. As a result, when the security requirement changes, the described mechanism may not need to make a change in the capabilities because the actual security metric exceeded the previous security requirement, and still meets the updated security requirement. This further aligns with the discussed anticipated future security requirement, where the mechanism may select capabilities which meet the anticipated security requirement, such that when the security requirement updates, no change is required in the capabilities selected.

Correspondingly to the NS security requirements, VNF security requirements may be fulfilled. In this case, the following steps may be performed, which largely correspond to the steps described for NS security requirements:

VNF Requirements Used to Select its Capabilities
1) VNF security requirements are used to select multiple candidate capabilities (i.e. NFVIs having respective functional capabilities) meeting the VNF security requirements.
   a. VNF security requirements
      i. Represents the security trust level requirement for each deployment flavour of the VNF
      ii. The security requirement may be stated as a score, between e.g. 1 and 100. In some of these embodiments, lower values are more trusted. In some of these embodiments, the score value has to be below a threshold. In other of these embodiments, higher values are more trusted. In some of these embodiments, the score value has to be higher than a threshold.
      iii. In some embodiments, there may be a requirement value for capabilities within specific subareas. E.g. there might be a required value for the vendor specific attributes, in addition to an overall trust level requirement.
      iv. The security_deployment_flavour has a cardinality from 1 to N within the VNF descriptor (VNFD) (N=1, 2, 3, . . . ). I.e., there may be an entry of a security trust level requirement for each of several subareas, the overall security, and the anticipated future (overall) security.
      v. In one example with N=3,
         1. The first value of the security_deployment_flavour requirement conveys the requirement on the overall security of the VNF.
         2. The second value of the security_deployment_flavour requirement conveys the requirement on vendor specific attributes of the VNF.
         3. A third value may convey a anticipated future security requirement of the VNF. This future requirement, does not yet need to be met, but the system can potentially avoid updating the supporting capabilities, when this future requirement becomes a current requirement. This future requirement may also have a future time associated with it (i.e., a time when the future security requirements have to be met).
   b. These VNF requirements are then used to identify a set of capabilities, that meet the VNF security requirements. I.e, based on security levels of the NFVIs, it may be determined if the VNF implemented on the NFVI(s) fulfills the VNF security requirements. The security levels of the NFVIs may be expressed by security attributes.
   c. The security metric for a given set of capabilities may be calculated using individual (security) attributes of the individual capabilities. For example, an average may be calculated across the individual capability values (wherein each capability value has a security value between 1 and 100). The average may be weighted according to a relative importance of some criteria. Instead of an average, a median or a minimum (maximum) value may be determined.
   d. The individual capabilities, for which security attributes may be determined, may include one or more of, e.g.:
      i. HW capabilities example
         1. NFVI capabilities include definition of the vendor for the hardware on which the VNF will run.
         2. Attribute Description
         3. Location US, China, Canada
         4. Vendor Trusted/Un-trusted, vendor id, description
         5. Virtualization type Private/Public/Hybrid
         6. Other tenants Trusted/Un-trusted
      ii. Software capabilities
         1. Software capabilities refers to the software component of the VNF, e.g. in terms of whether it is using a SW image of vendor A or a SW image of vendor B
         2. Attribute Description
         3. Location US, China, Canada
         4. Vendor Trusted/Un-trusted, vendor id, description
         5. Virtualization type Private/Public/Hybrid
         6. Other tenants Trusted/Un-trusted
      iii. Network capabilities
         1. This refers to networking gear, e.g. gear which may be from vendor C or vendor D, where the gear may further involve SDN
         2. Attribute Description
         3. Location US, China, Canada
         4. Vendor Trusted/Un-trusted, vendor id, description
         5. Virtualization type Private/Public/Hybrid
         6. Other tenants Trusted/Un-trusted
      iv. NFVi (NFV Infra) Capabilities—Cloud Capabilities
   e. By an implementation dependent function (e.g. sum) according to some embodiments of the invention, the VNF composite security metric attributes may be derived from these attributes.
      i. For example, as discussed, an average is calculated across the individual capability values (where each capability value has a security value between 1 and 100)
      ii. This average is then compared with the overall required value (the security requirement) for the VNF (as described earlier).
      iii. When there is a requirement on a single value, this may be an example of a “discriminative requirement,” e.g. where it is absolutely required that a security requirement in a certain area is matched. certain vendors are not allowed. For example, certain vendors may not be allowed. For example, the second value of the security_deployment_flavour requirement conveys the requirement on specific vendor attributes of the VNF. If certain vendors are not allowed, the respective attribute should be high (in case, lower values mean higher trust) such that they are above a threshold value.
2) In the case where the future security requirement is higher than the current, some embodiments may additionally identify capabilities which satisfy the future security requirement.
3) After identifying this set of candidates capabilities (meeting the VNF security requirement) are identified, a further optimization process may be used to select among the candidates, by taking into account factors such as scalability, cost, and performance.
   a. The cost and performance difference between the capabilities meeting the current and future requirements are then compared with the threshold. This threshold may further be calculated as a function of the processing or messaging costs required to update an instantiation, changing the capabilities, etc.
4) Once the specific capabilities are selected, then a VNF security value may be calculated to represent the actual security metric for the selected set of NFVI capabilities.
   a. In this case note that the selected set of VNF capabilities value, can actually have a lower value than the corresponding VNF requirement according to the VNFD. As a result, when the security requirement changes, the described mechanism may not need to make a change in the capabilities because the actual security metric exceeded the previous security requirement, and still meets the updated security requirement. This further aligns with the discussed anticipated future security requirement, where the mechanism may select capabilities which meet the anticipated security requirement, such that when the security requirement updates, no change is required in the capabilities selected.

According to some embodiments of the invention, new fields are added to one or both of the network service descriptor (NSD) and the VNF descriptor (VNFD) covering the security requirement for the network service and virtual network function respectively. According to gs_NFV-MONO01v010101p—Management and Orchestration, the Network Service Descriptor (NSD) consists of static information elements as defined below. It is used by the NFV Orchestrator to instantiate a Network Service, which would be formed by one or more VNF Forwarding Graphs, VNFs, PNFs and VLs. The NSD also describes deployment flavours of Network Service.

An example of an updated definition (only the new element is shown) of nsd base element and vnfd base information elements are shown in Tables 1 and 2, respectively.

TABLE 1
NSD base element

| Identifier | Type | Cardinality | Description |
|---|---|---|---|
| . . . | | | |
| security | Element | 1 . . . N | Represents the |
| deployment | | | security parameters |
| flavor | | | and its requirement for |
| | | | each deployment |
| | | | flavour of the NS being |
| | | | described. |
| . . . | | | |

TABLE 2
vnfd base information element

| Identifier Type | Identifier Type | Identifier Type | Identifier Type |
|---|---|---|---|
| Cardinality | Cardinality | Cardinality | Cardinality |
| Description | Description | Description | Description |
| . . . | | | |
| security | Element | 1 . . . N | Represents the |
| deployment | | | security capabilities |
| flavour | | | for |
| | | | each deployment |
| | | | flavour of the VNF |
| | | | being described |

In other words, some embodiments of the invention may be described as according to the following clauses 1 to 12:
1) The method for VNF capabilities selection process, selecting multiple candidates with capabilities, in order to optimize security aware instantiation of network service and functions comprising:
   a. Determining a security requirement for network service (NS)
   b. In response to determining a security requirement, calculating a security metric value for each of a plurality of VNF (virtualized network function) capabilities for meeting the NS security requirement.
   c. Using the security metric for the plurality of VNF capabilities, to identify (a plurality of) VNF capabilities meeting the NS (network service) security requirement.
2) Optionally include it in the first clause:
   a. Then performing an optimization process to select among the plurality of VNF capabilities found to meet the network service requirements, where this additional optimization take into account at least one of
      i. a future network service security requirement
      ii. scalability, cost, and performance.
   b. Then performing an optimization process to select among the plurality of VNF capabilities found to meet the network service requirements, where this additional optimization take into account at least one of scalability, cost, and performance.
3) The method of clause 1 or 2 wherein
   a. the future network service security requirement further comprises an associated time when the security requirement is anticipated to change
4) The method of any of clauses 1 to 3 wherein the network service requirement is used to select a set of capabilities meeting the network service requirement (VNF capabilities, NFVI capabilities, software capabilities, network capabilities as per the first section of the embodiment description above)
5) The method of any of clauses 1 to 4, wherein the network service requirement is a VNF requirement, where in this VNF requirement is then used to select a set of capabilities meeting the network service requirement (e.g. NFVI capabilities, software capabilities, and network capabilities as per second section of the embodiment description above)
6) The method of any of clauses 1 to 5, wherein the VNF capabilities includes the
   a. The security capability corresponding to at least one of
      i. a virtual network function (VNF) and
      ii. a NFVI (network function virtualization infrastructure)
      iii. a software capabilities
      iv. a network capability
      v. a cloud capability
   b. is compared with a security requirement of at least one of
      i. a Network service,
      ii. a virtualized network function.
7) The method of any of clauses 1 to 6, wherein in response to this comparison, performing VNF changes comprising of at least one of:
   a. instantiation,
   b. scale up,
   c. scale down,
   d. update,
   e. upgrade,
   f. change in security requirements,
   g. change in security policy.
8) The method of any of clauses 1 to 7, wherein a numeric function is used to combine the security metrics for the individual capabilities to create a overall security metric of the capabilities for comparison with the security requirement
   a. The method of claim 8 wherein the determination of whether the capabilities meet the security requirement comprises calculating a weighted average of the attribute of individual capabilities, and comparing this weighted-average with the (NS or VNF) security requirement.
9) The method of any of clauses 1 to 8, wherein the
   a. capabilities are a producer functional block, and
   b. wherein the requirement is a consumer functional block
10) The method of any of clauses 1 to 9, wherein
   a. performing the change comprises selecting the VNF capabilities for comparison with NS security requirement
11) The method of any of clauses 1 to 10, wherein
   a. performing the change comprises selecting the (NFVI) capabilities for comparison with the (VNF) security requirements
12) The method of any of clauses 1 to 11, wherein
   a. this selection process further comprises optimizing the selection to tradeoff cost, performance & security

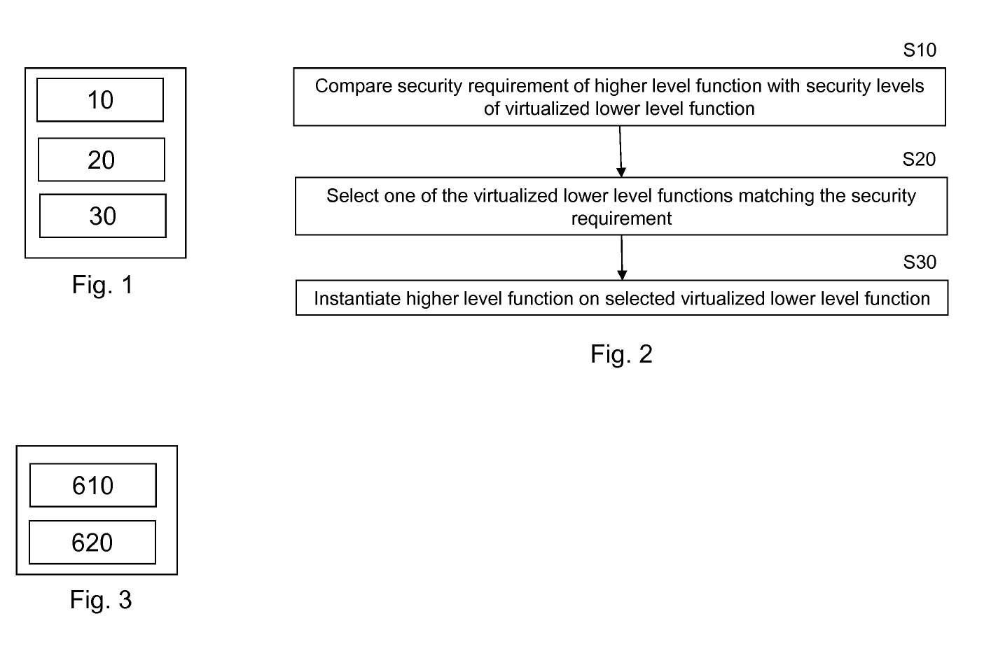

FIG. 1 shows an apparatus according to an example embodiment of the invention. The apparatus may be an orchestrator such as a NFV-MANO or an element thereof. FIG. 2 shows a method according to an example embodiment of the invention. The apparatus according to FIG. 1 may perform the method of FIG. 2 but is not limited to this method. The method of FIG. 2 may be performed by the apparatus of FIG. 1 but is not limited to being performed by this apparatus.

The apparatus comprises comparing means 10, selecting means 20, and instantiating means 30. The comparing means 10, selecting means 20, and instantiating means 30 may be a comparing circuitry, selecting circuitry, and instantiating circuitry, respectively.

The comparing means 10 compares a security requirement for a higher level function with respective security levels of one or more virtualized lower level functions (S10). Each of the one or more virtualized lower level functions is capable to deploy the higher level function. As described above, the higher level function may a network service or a network function and the lower level function may be a virtual network function, and/or the higher level function may be a virtual network function and the lower level function may be a networks functions virtualization infrastructure.

The selecting means 20 selects a selected virtualized lower level function of the one or more virtualized lower level functions (S20). The security level of the selected virtualized lower level function is equal to or higher than the security requirement for the higher level function. In other words, the security level of the selected virtualized lower level function at least matches the security requirement of the higher level function.

The instantiating means 30 instantiates the higher level function on the selected virtualized lower level function (S30).

FIG. 3 shows an apparatus according to an example embodiment of the invention. The apparatus comprises at least one processor 610, at least one memory 620 including computer program code, and the at least one processor 610, with the at least one memory 620 and the computer program code, being arranged to cause the apparatus to at least perform at least the method according to FIG. 2 and related description.

In some embodiments of the invention described herein, the capabilities (virtualized lower level functions) are selected first, which fulfill the security requirements of the higher level function. Then, other requirements such as costs and performance are considered to finally select the capabilities on which the higher level function is instantiated.

According to some embodiments of the invention, one or more of the other requirements are considered first, and, thus, a subset of virtualized lower level functions is selected. Then, the selection of the virtualized lower level function in view of the security requirement is based on the subset.

In some embodiments of the invention, security and some other selection criteria may be considered simultaneously. In these cases, the selection may be made based on a metric which combines the security requirements with the other requirements.

One piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software.

Some example embodiments of the invention may be applied to a 3GPP network (e.g. LTE, LTE-A, or a 5G network), as described herein. However, some example embodiments of the invention may be applied to any kind of network wherein a network function or a network service is virtualized.

According to the above description, it should thus be apparent that example embodiments of the present invention provide, for example an orchestrator, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques, means, entities, units, devices, or methods include, as non-limiting examples, implementations as hardware, software, firmware, special purpose circuits or logic, general purpose hardware or controller or other computing devices, a virtual machine, or some combination thereof.

It should be noted that the description of the embodiments is given by way of example only and that various modifications may be made without departing from the scope of the invention as defined by the appended claims.

1. An apparatus, comprising:
comparing means for comparing a security requirement for a higher level function with respective security levels of one or more virtualized lower level functions, wherein each of the one or more virtualized lower level functions is configured to deploy the higher level function;
selecting means for selecting a selected virtualized lower level function of the one or more virtualized lower level functions, wherein the security level of the selected virtualized lower level function is equal to or higher than the security requirement; and
instantiating means for instantiating the higher level function on the selected virtualized lower level function.

2. The apparatus according to claim 1, wherein
the higher level function comprises a network service or a network function and the lower level function is a virtual network function, or
the higher level function comprises a virtual network function and the lower level function comprises a networks functions virtualization infrastructure.

3. The apparatus according to claim 1, wherein
the selecting means is additionally configured to take into account, for selecting the selected lower level function, at least one of a future security requirement for the higher level function, a scalability of the higher level function deployed on the selected lower level function, costs to deploy the higher level function on the selected lower level function, and a performance of the higher level function deployed on the selected lower level function.

4. The apparatus according to claim 1, wherein
the security requirement and each of the security levels is expressed by a respective numerical value;
the comparing means is configured to compare the numerical value of the security requirement with the respective numerical value of each of the one or more lower level functions; and wherein
the selecting means is configured to select the selected lower level function if the numerical value of the security requirement and the numerical value of the security level of the selected lower level function fulfill a predetermined relationship.

5. The apparatus according to claim 1, wherein
the security requirement comprises plural security sub-requirements and each of the security levels comprises corresponding plural security sub-levels;
the comparing means is configured to compare one or more of the plural security sub-requirements with the corresponding security sub-level of each of the virtualized lower level functions; and wherein
the selecting means is configured to select the selected virtualized lower level function if each of the compared security sub-levels of the selected virtualized lower level function is equal to or higher than the corresponding security sub-requirement.

6. The apparatus according to claim 1, wherein
the security requirement comprises plural sub-requirements and each of the security levels comprises corresponding plural security sub-levels, and wherein the apparatus further comprises
determining means for determining a global security requirement based on one or more of the plural security sub-requirements and to determine a respective global security level for each of the lower level functions based on the corresponding one or more of the security sub-levels;
wherein
the comparing means is configured to compare the global security requirement with the respective global security levels and wherein
the selecting means is configured to select the selected virtualized lower level function if the global security level of the selected virtualized lower level function is equal to or higher than the global security requirement.

7. The apparatus according to claim 1, further comprising:
control means for controlling the comparing means, the selecting means, and the instantiating means such that, in a first step, the higher level function is a network service or a network function, the virtualized lower level functions are virtualized network functions, and the selected virtualized lower level function is one of the virtualized network functions, and, in a second step following the first step, the higher level function is the selected virtualized network function, the virtualized lower level functions are network functions virtualization infrastructures, and the selected virtualized lower level function is one of the network functions virtualization infrastructures.

8. The apparatus according to claim 1, further comprising:
determining means for determining at least one of the security levels based on at least one of an attribute, a location, a vendor, a virtualization type, and other tenants of the respective virtualized lower level function.

9. A method, comprising:
comparing a security requirement for a higher level function with respective security levels of one or more virtualized lower level functions, wherein each of the one or more virtualized lower level functions is capable to deploy the higher level function;
selecting a selected virtualized lower level function of the one or more virtualized lower level functions, wherein the security level of the selected virtualized lower level function is equal to or higher than the security requirement; and
instantiating the higher level function on the selected virtualized lower level function.

10. The method according to claim 9, wherein
the higher level function comprises a network service or a network function and the lower level function is a virtual network function, or
the higher level function comprises a virtual network function and the lower level function is a networks functions virtualization infrastructure.

11. The method according to claim 9, wherein
the selecting takes additionally into account, for selecting the selected lower level function, at least one of a future security requirement for the higher level function, a scalability of the higher level function deployed on the selected lower level function, costs to deploy the higher level function on the selected lower level function, and a performance of the higher level function deployed on the selected lower level function.

12. The method according to claim 9, wherein
the security requirement and each of the security levels is expressed by a respective numerical value;
the numerical value of the security requirement is compared with the respective numerical value of each of the one or more lower level functions; and wherein
the selected lower level function is selected if the numerical value of the security requirement and the numerical value of the security level of the selected lower level function fulfill a predetermined relationship.

13. The method according to claim 9, wherein
the security requirement comprises plural security sub-requirements and each of the security levels comprises corresponding plural security sub-levels;
one or more of the plural security sub-requirements are compared with the corresponding security sub-level of each of the virtualized lower level functions; and wherein
the selected virtualized lower level function is selected if each of the compared security sub-levels of the selected virtualized lower level function is equal to or higher than the corresponding security sub-requirement.

14. The method according to claim 9, wherein
the security requirement comprises plural sub-requirements and each of the security levels comprises corresponding plural security sub-levels, and wherein the method further comprises
determining a global security requirement based on one or more of the plural security sub-requirements and to determine a respective global security level for each of the lower level functions based on the corresponding one or more of the security sub-levels,
wherein
the global security requirement is compared with the respective global security levels, and
the selected virtualized lower level function is selected if the global security level of the selected virtualized lower level function is equal to or higher than the global security requirement.

15. The method according to claim 9, further comprising:
controlling the comparing of the security requirement with the respective security levels, the selecting of the selected virtualized lower level function, and the instantiating of the higher level function such that, in a first step, the higher level function is a network service or a network function, the virtualized lower level functions are virtualized network functions, and the selected virtualized lower level function is one of the virtualized network functions, and, in a second step following the first step, the higher level function is the selected virtualized network function, the virtualized lower level functions are network functions virtualization infrastructures, and the selected virtualized lower level function is one of the network functions virtualization infrastructures.

16. The method according to claim 9, further comprising:
determining at least one of the security levels based on at least one of an attribute, a location, a vendor, a virtualization type, and other tenants of the respective virtualized lower level function.

17. A computer program product embodied on a non-transitory computer-readable medium, said product comprising a set of instructions which, when executed on an apparatus, is configured to cause the apparatus to carry out the method according to claim 9.

18. (canceled)

19. An apparatus, comprising:
at least one processor; and
at least one memory including computer program code;
the at least one memory and the computer program code configured to, with the at least one processor, cause the apparatus at least to perform comparing a security requirement for a higher level function with respective security levels of one or more virtualized lower level functions, wherein each of the one or more virtualized lower level functions is capable to deploy the higher level function;
selecting a selected virtualized lower level function of the one or more virtualized lower level functions, wherein the security level of the selected virtualized lower level function is equal to or higher than the security requirement; and
instantiating the higher level function on the selected virtualized lower level function.

20. The apparatus according to claim 19, wherein
the higher level function comprises a network service or a network function and the lower level function is a virtual network function, or
the higher level function comprises a virtual network function and the lower level function is a networks functions virtualization infrastructure.

21. The apparatus according to claim 19, wherein the selecting takes additionally into account, for selecting the selected lower level function, at least one of a future security requirement for the higher level function, a scalability of the higher level function deployed on the selected lower level function, costs to deploy the higher level function on the selected lower level function, and a performance of the higher level function deployed on the selected lower level function.
